(19) United States
(12) Patent Application Publication
(10) Pub. No.: US 2007/0286701 A1
(43) Pub. Date: Dec. 13, 2007

(54) Wood screw with cutting teeth on threads and groove in shank

(76) Inventor: Kuo-Tai Hsu, Yong Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/448,086

(22) Filed: Jun. 7, 2006

(51) Int. Cl. F16B 25/10

(52) U.S. Cl. 411/387.1

(57) ABSTRACT

A wood screw includes a head and a shank which includes a screw-in portion including a tapered section and a tip point at a distal end of the tapered section. A groove is defined longitudinally in the shank and starts from the tapered section and extends toward the head. A plurality of threads are formed on an outer periphery of the shank including the screw-in portion. A plurality of cutting teeth are formed on the threads on the screw-in portion. A plurality of ribs extend spirally from an outer periphery of the shank and located between the threads.

### FIELD OF THE INVENTION

The present invention relates to a wood screw which includes teeth on the threads of the screw-in portion and a groove in the shank so as to be quickly screwed in an object and the debris can be removed efficiently.

### BACKGROUND OF THE INVENTION

Applicant's former U.S. Pat No. 6,789,991 discloses a screw that has spirally arranged cutting trenches defined in the shank of the screw and the trenches are located between the threads. The cutting trenches improve cutting the texture of the object so that the screw can be quickly screwed into the object. However, during the first stage of screwing, the screw lacks strong and sufficient cutting edges so that the user has to apply a large force to force the screw into the object. The texture of the object might clamp the thin threads and break the threads. Besides, the debris of the object applies a transverse force which might cause cracks to the object. U.S. Pat. No. 6,056,491 discloses a screw that has cutting teeth formed on the threads and the cutting teeth are helpful at the first screwing stage. Nevertheless, the debris cannot be quickly removed from the bore formed by the screw, especially when the flat section of the screw merges into the object.

The present invention intends to provide a wood screw that has cutting teeth formed on the threads of the screw-in portion of the shank so as to quickly screw into the object, and a groove is defined in the shank and provides a sufficient space for removing the debris during screwing.

### SUMMARY OF THE INVENTION

The present invention relates to a wood screw that comprises a head and a shank which includes a screw-in portion including a tapered section and a tip point at a distal end of the tapered section. A groove is defined longitudinally in the shank and two cutting edges are formed on two sides of the groove. A plurality of threads are formed on an outer periphery of the shank including the screw-in portion. A plurality of cutting teeth are formed on the threads on the screw-in portion. A plurality of ribs extend from an outer periphery of the shank and located between the threads.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a side view of the wood screw of the present invention;

FIG. 2 is a perspective view to show the wood screw of the present invention;

FIG. 3 shows an enlarged cross sectional view along line P-P′ of the wood screw of the present invention;

FIG. 4 shows that the wood screw is screwed into an object;

FIG. 5 shows that debris received in the groove of the wood screw of the present invention, and

FIG. 6 shows an enlarged view of the crest portions of the cutting teeth and the threads of the wood screw of the present invention.

### DETAILED DESCRIPTION OF THE PREFERRED EMBODIMENT

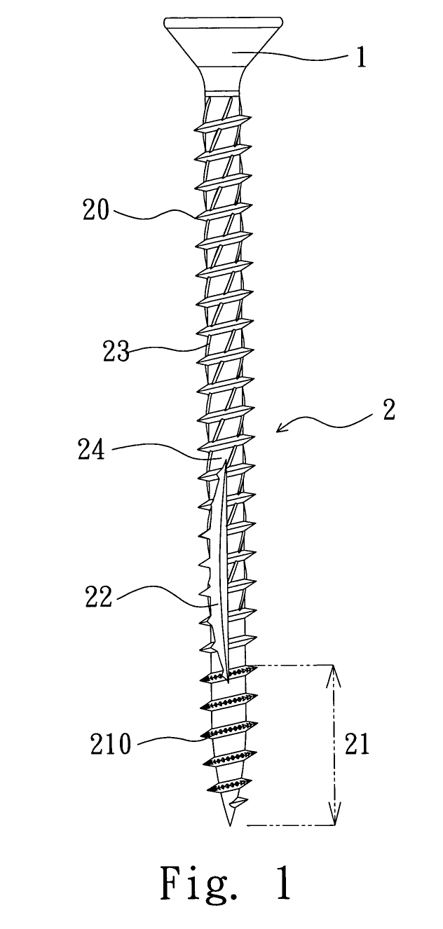

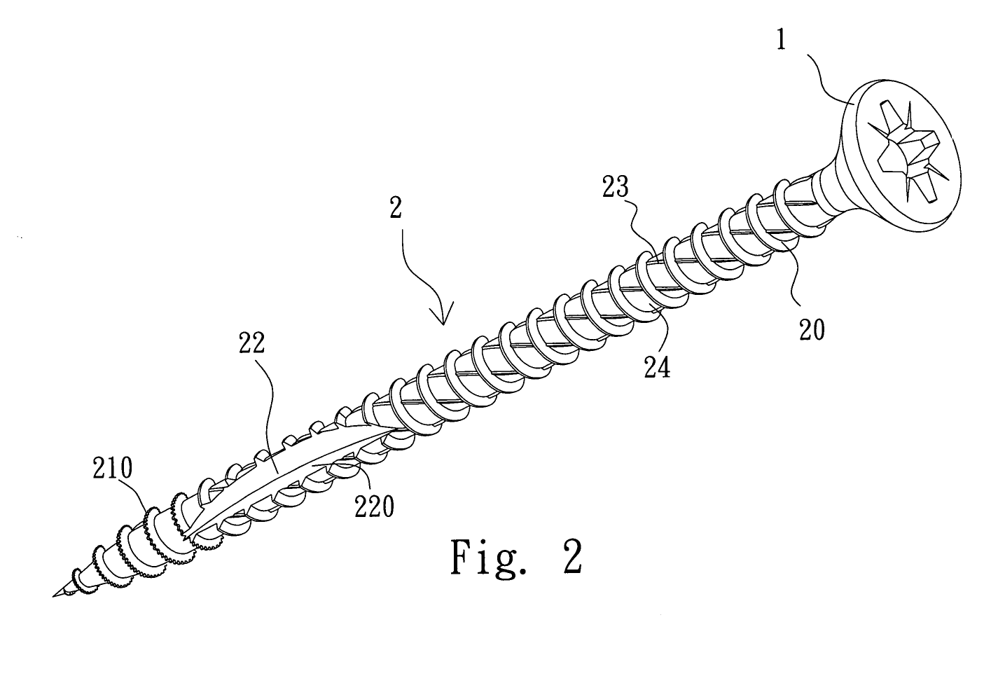

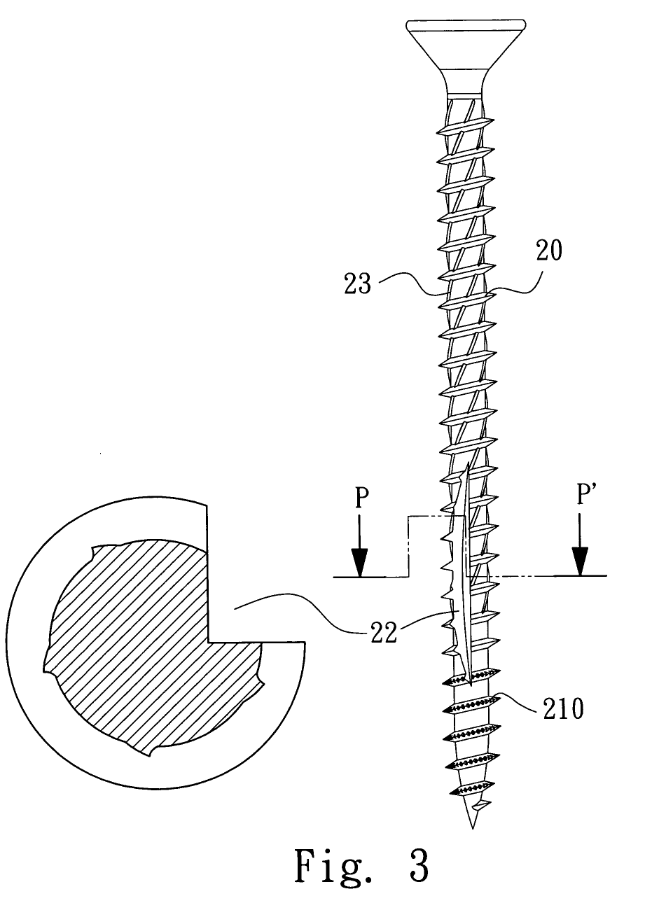

Referring to FIGS. 1 to 3, the wood screw of the present invention comprises a head 1 and a shank 2 which has a first end connected with the head 1 and a screw-in portion 21 on a second end of the shank 2. The screw-in portion 21 which includes a tapered section and a tip point at a distal end of the tapered section. A groove 22 is defined longitudinally in the shank 2 and two cutting edges 220 are formed on two sides of the groove 22.

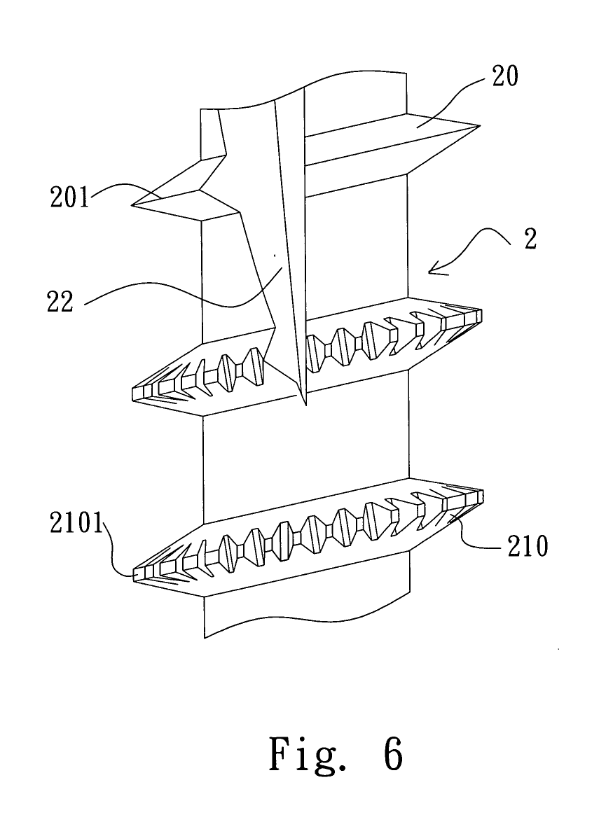

A plurality of threads 20 are formed on an outer periphery of the shank 2 including the screw-in portion 21. A plurality of cutting teeth 210 are formed on the threads 20 on the screw-in portion 21. The groove 22 starts from a far-most cutting teeth 210 from the tip point and extends toward the head 1. A plurality of ribs 23 spirally extend from an outer periphery of the shank 2 and are located between the threads 20. The ribs 23 start from the first end of the shank 2 and terminate before the screw-in portion 21. As shown in FIG. 6, each cutting tooth 210 has a crest portion 2101 which is wider than a crest portion 201 of the threads 20.

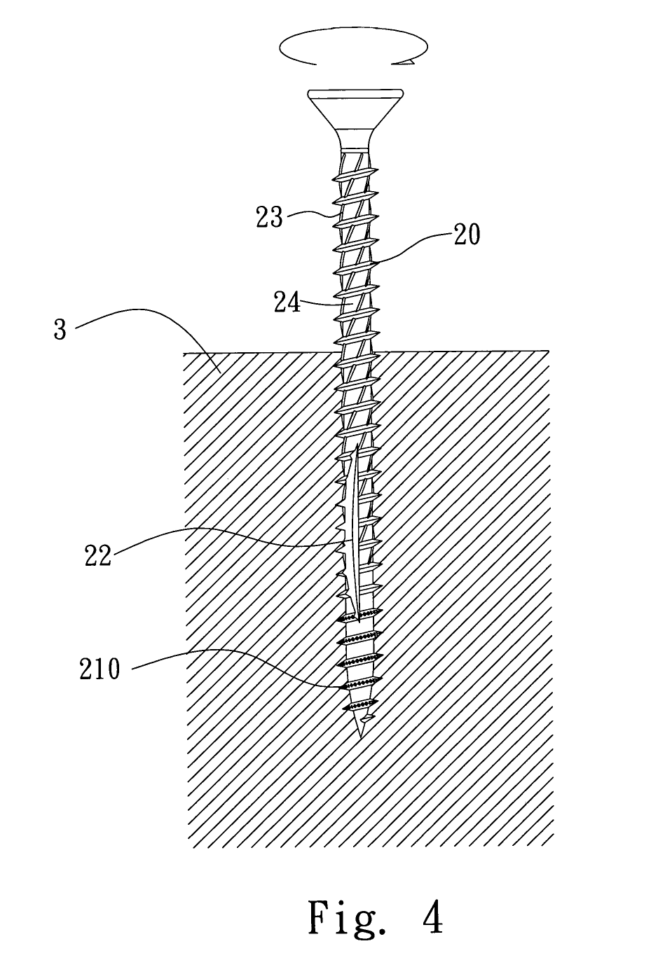

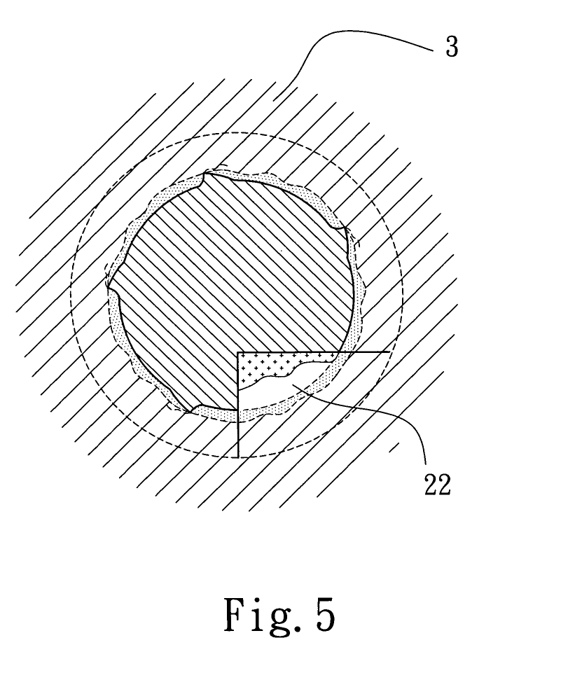

As shown In FIGS. 4 and 5, when screwing the wood screw into an object 3, the cutting teeth 210 of the threads 20 on the screw-in portion 21 can efficiently cut the fibers of the object 3 so as to easily screw into the object 3. The debris of the object 3 can be removed from the groove 22 and the cutting edges 220 of the groove 22 also assist the movement of the wood screw into the object 3. By the specific design of the wood screw, the user can easily screw the wood screw into the object 3. Besides, ribs 23 assist the shank 2 to merge into the object 3 and guide debris out from the bore that the wood screw made. The wider crest portions 2101 of the cutting teeth 210 prevent the cutting teeth 210 from being clamped and/or broken by the material of the object 3.

While we have shown and described the embodiment in accordance with the present invention, it should be clear to those skilled in the art that further embodiments may be made without departing from the scope of the present invention.

What is claimed is:

1. A wood screw comprising:
a head and a shank connected to the head, the shank including a screw-in portion which includes a tapered section and a tip point at a distal end of the tapered section, a groove defined longitudinally in the shank and two cutting edges being formed on two sides of the groove, a plurality of threads formed on an outer periphery of the shank including the screw-in portion, a plurality of cutting teeth formed on the threads on the screw-in portion, a plurality of ribs extending from an outer periphery of the shank and located between the threads.

2. The wood screw as claimed in claim 1, wherein the ribs extend spirally from the outer periphery of the shank.

3. The wood screw as claimed in claim 1, wherein each cutting tooth has a crest portion which is wider than a crest portion of the threads.

4. The wood screw as claimed in claim 1, the groove starts from a far-most cutting teeth from the tip point and extends toward the head.

5. The wood screw as claimed in claim 1, the ribs start from a first end of the shank and the first end of the shank is connected with the head, the ribs terminate before the screw-in portion.
